(19) United States
(12) Patent Application Publication
(10) Pub. No.: US 2004/0160935 A1
(43) Pub. Date: Aug. 19, 2004

(54) System and method for sensing carrier on mobile station side in personal handyphone system

(75) Inventor: Tadao Hashimoto, Shizuoka (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/779,971

(22) Filed: Feb. 17, 2004

Related U.S. Application Data
(63) Continuation of application No. 09/443,691, filed on Nov. 19, 1999.

(30) Foreign Application Priority Data
Nov. 20, 1998 (JP) 330364/1998

(51) Int. Cl. G06F 7/00

(52) U.S. Cl. 370/345

(57) ABSTRACT

A personal handyphone system performing radio connection using a time division multiple access (TDMA)-time division duplex (TDD) system includes a mobile station which includes means for performing carrier sensing of a communication frequency designated by a base station and a reception slot, and means for performing carrier sensing of a transmission slot.

### BACKGROUND OF THE INVENTION

1. Field of the Invention

The present invention relates generally to a system and a method for sensing a carrier of a mobile station in a personal handyphone system (PHS). More particularly, the invention relates to a system and a method for sensing a carrier in a self-supporting system, in which asynchronous Time Division Multiple Access (TDMA) system is present in admixing manner.

2. Description of the Related Art

Conventionally, in a radio communication system according to a TDMA system, upon performing radio communication between a plurality of base stations and mobile stations using the same frequency, carrier sensing is performed in each station in order to check whether a radio wave is transmitted from other station before initiation of communication, in order to avoid interference between a radio wave of own station and a radio wave from other station. As a result of carrier sensing, if the radio wave from other station is not detected, communication is initiated.

In case of a personal handyphone system (PHS), a base station performs carrier sensing of communication frequency and slot intended to be used. If the radio wave from other station is not detected in the communication frequency and slot intended to be used, judgment is made that the communication and slot in question are not used to designate those communication frequency and slot for the mobile station using a control frequency and slot. The mobile station performs carrier sensing of the communication frequency and communication slot designated by the base station. Then, if the radio wave from other station is not detected, communication is initiated.

In the first edition of standard specification relating to the personal handyphone system RCR STD-28 (established on Dec. 20, 1993), a function to only perform establishment of slot intended for reception and a fixed reception electric field level is defined as carrier sensing level, concerning carrier sensing system of the communication slot of the base station and the mobile station.

FIG. 9 is a flow diagram showing the conventional state transition upon connection of the communication channel of the mobile station. FIG. 6 is a sequence chart showing a communication channel connection sequence between the mobile station and the base station. In ON-hook state of the mobile station, a communication channel (CH) and slot assignment demand signal 61 (see FIG. 6) is transmitted to the base station (step 901). Then, the base station performs carrier sensing at the communication frequency and the communication slot intended to be used. If no radio wave from other station is detected in the communication frequency and the slot intended to be used, judgment is made that those communication frequency and slot are not used to perform designation of the communication frequency and the communication slot for the mobile station. Upon reception of the communication channel (CH) ands slot assignment signal 62, the mobile station performs carrier sensing operation for a reception slot having the designated communication frequency and slot (steps 902 and 903). When an electric field level is higher than or equal to a given level, the communication channel assignment demand signal is transmitted to the base station (step 904). If the communication frequency and slot are not used (the electric field level is less than the given level), for the base station, a synchronization signal 63 (see FIG. 6) is transmitted using the designated communication frequency and communication slot (step 906) to wait for the synchronization signal. After reception of the synchronization signal 64 (see FIG. 6) from the base station, state is transit to communication state.

One example of carrier sensing operation in the conventional mobile station will be discussed briefly. Referring to FIG. 3, since a mobile station (A) 34 performs carrier sensing operation for only reception slot of a designated communication frequency, on-going communication between a base station (B) 31 and a mobile station (B) 35 cannot be detected. Thus, communication between the mobile station (A) 34 and a base station (A) 30 is initiated at the same frequency as the communication frequency of on-going communication between the base station (B) 31 and the mobile station (B) 35. Therefore, since the communication frequency in on-going communication between the base station (A) 30 and the mobile station (A) 34 and the communication frequency of communication between the base station (B) 31 and the mobile station (B) 35 are the same, if the mobile station (B) 35 is moved to approach the mobile station (A) 34, radio interference is caused due to superimposition of the transmission slot in communication in the mobile station (B) 35 on a reception slot in communication in the mobile station (A) 34.

As set forth above, in the carrier sensing system of the conventional personal handyphone system (PHS), carrier sensing level of only reception slot intended to be used is performed in own base station and own mobile station for initiating communication. Therefore, immediately after initiation of communication, there is low possibility to cause radio interference from other mobile station. Accordingly, actually, the transmission slot of the own mobile station has already been used by other mobile station. In the case where judgment is made that no carrier is present upon carrier sensing of the reception slot of the own base station, when other mobile station moves to approach to the own mobile station after initiation of communication, or when the own mobile station moves to approach other station, radio interference is inherently caused.

On the other hand, since the carrier sensing level upon carrier sensing of the mobile station is constant irrespective of the reception level of the control signal from the own base station, even when the interference wave higher than or equal to the reception electric field level of the control signal from the own base station is detected upon carrier sensing, judgment is made that the slot is not used to initiate communication. In this case, radio interference is caused immediately after initiation of communication.

### SUMMARY OF THE INVENTION

It is therefore an object of the present invention to provide a method and a system for sensing carrier for preventing radio interference in communication state.

According to the first aspect of the invention, a personal handyphone system performing radio connection using a time division multiple access-time division duplex system comprises

a mobile station including

means for performing carrier sensing of a communication frequency designated by a base station and a reception slot, and

means for performing carrier sensing of a transmission slot.

In the preferred construction, the mobile station further comprises means for initiating communication when non use is judged in both carrier sensing.

In another preferred construction, the mobile station further comprises means for initiating communication when non use is judged in both carrier sensing,

in carrier sensing of the reception slot and carrier sensing of the transmission slot, setting of reception electric field level as judgment condition of non use is provided individually to perform carrier sensing on the basis of each of the reception electric field levels.

In another preferred construction, the mobile station further comprises means for initiating communication when non use is judged in both carrier sensing, setting means for modifying and setting the reception electric field level as non use judgment condition in carrier sensing,

the setting means setting the reception electric field level as non use judgment condition at an appropriate value corresponding to a reception electric field level of a control frequency and a control slot from the case station.

In another preferred construction, the mobile station further comprises means for initiating communication when non use is judged in both carrier sensing, setting means for modifying and setting the reception electric field level as non use judgment condition in carrier sensing,

in carrier sensing of the reception slot and carrier sensing of the transmission slot, setting of reception electric field level as judgment condition of non use is provided individually to perform carrier sensing on the basis of each of the reception electric field levels,

setting means for modifying and setting the reception electric field level as non use judgment condition in carrier sensing,

the setting means setting the reception electric field level as non use judgment condition at an appropriate value corresponding to a reception electric field level of a control frequency and a control slot from the case station.

According to the second aspect of the invention, a carrier sensing method on a mobile station side of a personal handyphone system performing radio connection using a time division multiple access-time division duplex system comprises

in the mobile station,

performing carrier sensing of a communication frequency designated by a base station and a reception slot, and

performing carrier sensing of a transmission slot.

In the preferred construction, the carrier sensing method further comprising the step of, in the mobile station,

initiating communication when non use is judged in both carrier sensing.

In another preferred construction, the carrier sensing method further comprising the step of, in the mobile station,

initiating communication when non use is judged in both carrier sensing,

in carrier sensing of the reception slot and carrier sensing of the transmission slot, setting of reception electric field level as judgment condition of non use is provided individually to perform carrier sensing on the basis of each of the reception electric field levels.

In another preferred construction, the carrier sensing method further comprising the step of, in the mobile station, initiating communication when non use is judged in both carrier sensing, modifying and setting the reception electric field level as non use judgment condition in carrier sensing, setting the reception electric field level as non use judgment condition at an appropriate value corresponding to a reception electric field level of a control frequency and a control slot from the case station.

In another preferred construction, the carrier sensing method further comprising the step of, in the mobile station, initiating communication when non use is judged in both carrier sensing, modifying and setting the reception electric field level as non use judgment condition in carrier sensing,

in carrier sensing of the reception slot and carrier sensing of the transmission slot, setting of reception electric field level as judgment condition of non use is provided individually to perform carrier sensing on the basis of each of the reception electric field levels,

modifying and setting the reception electric field level as non use judgment condition in carrier sensing,

setting the reception electric field level as non use judgment condition at an appropriate value corresponding to a reception electric field level of a control frequency and a control slot from the case station.

According to another aspect of the invention, a mobile station of a personal handyphone system performing radio connection using a time division multiple access-time division duplex system comprises means for performing carrier sensing of a communication frequency designated by a base station and a reception slot, and means for performing carrier sensing of a transmission slot.

Further object, feature and effect of the present invention will become apparent from the detailed description given hereinafter.

### BRIEF DESCRIPTION OF THE DRAWINGS

The present invention will be understood more fully from the detailed description given herebelow and from the accompanying drawings of the preferred embodiment of the present invention, which, however, should not be taken to be limitative to the invention, but are for explanation and understanding only.

In the drawings:

FIG. 1 is an illustration showing a slot construction in the case of occurrence of radio interference in one embodiment of a personal handyphone system according to the present invention;

FIG. 2 is a block diagram showing a construction of one embodiment of a mobile station according to the present invention;

FIG. 3 is an illustration showing a system construction of the case where radio interference is caused in the personal handyphone system;

FIG. 4 is an illustration showing the slot construction of the personal handyphone system;

FIG. 5 is an illustration showing a carrier sensing point in the personal handyphone system;

FIG. 6 is an illustration showing a communication channel connection sequence of the personal handyphone system;

FIG. 7 is an illustration showing a communication channel connection sequence of one embodiment of the mobile station according to the present invention;

FIG. 8 is an illustration showing a carrier sensing result judgment method of one embodiment of the mobile station according to the present invention; and

FIG. 9 is an illustration showing a communication channel connection sequence of the conventional mobile station.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details.

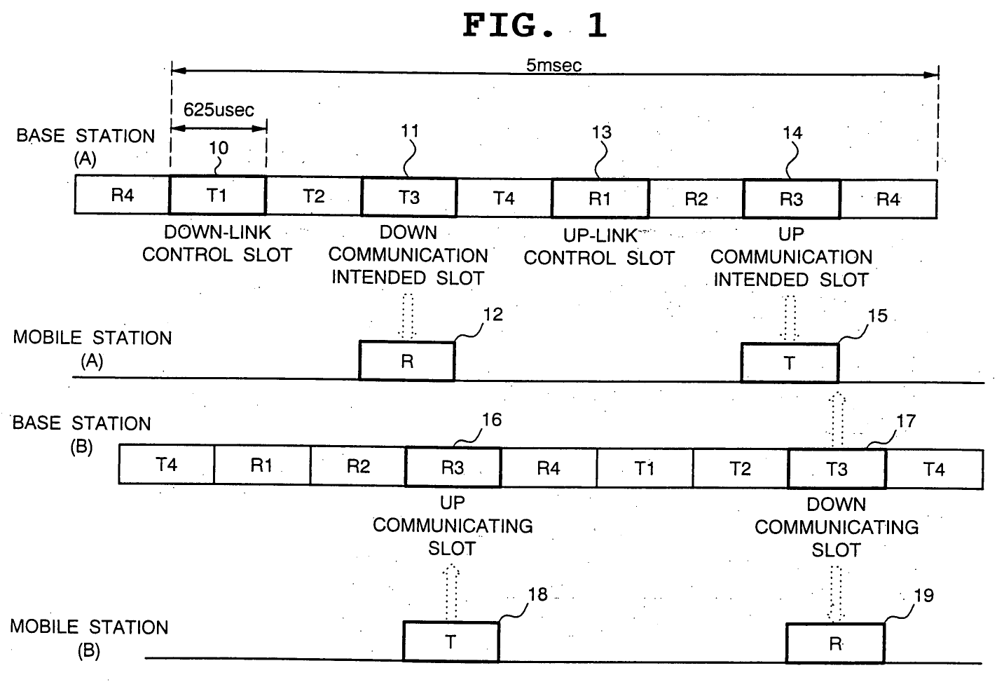

FIG. 1 is an illustration showing a slot construction in the case of occurrence of radio interference in one embodiment of a personal handyphone system according to the present invention.

An embodiment of the present invention will be discussed. In the shown embodiment of the present invention, a mobile station of a personal handyphone system has means for performing carrier sensing not only for a reception slot of the mobile station but also a transmission slot simultaneously, upon carrier sensing in response to designation of a communication frequency and a slot by a base station.

On the other hand, in the shown embodiment of the present invention, in carrier sensing in the mobile station, there is a construction to have a function to make the carrier sensing level variable instead of fixing.

Carrier sensing is performed not only for reception slot but also for transmission slot upon carrier sensing for preventing the own mobile station from using of the communication carrier which has already been used by other mobile station located near the own mobile station.

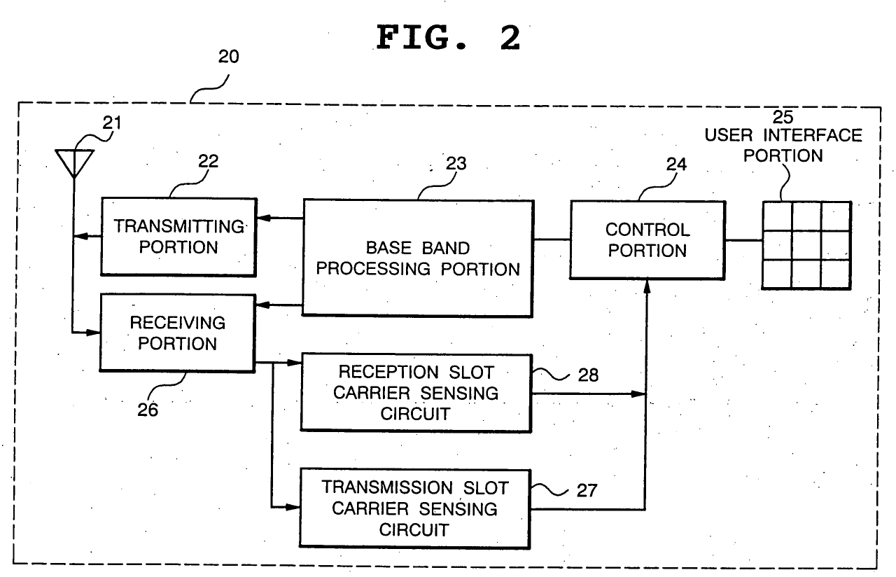

The preferred embodiment of the present invention will be discussed with reference to the drawings. FIG. 2 is a block diagram showing a construction of a mobile station of one embodiment of a personal handyphone system according to the present invention. Referring to FIG. 2, one embodiment of the mobile station according to the present invention includes an antenna portion 21, a transmitting portion 22, a base band processing portion 23, a control portion 24, a user interface portion 25, a receiving portion 26, a transmission slow carrier sensing circuit 27 and a reception slot carrier sensing circuit 28. Amongst, the transmission carrier sensing circuit 27 is an element constituting the feature of one embodiment of the present invention, and known elements may be used for other elements.

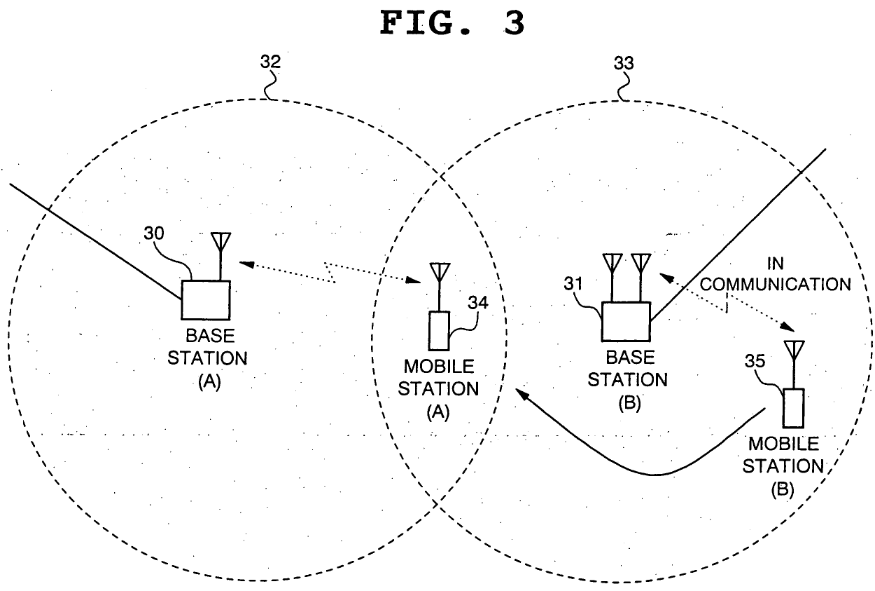

FIG. 3 is an illustration for explaining one embodiment of the present invention and showing a system construction of the personal handyphone system. Referring to FIG. 3, while the base station (B) 31 and the mobile station (B) 35 are in communication, the mobile station (A) 34 is about initiation of communication with the base station (A) 30. Since the mobile station (A) 34 is located within a service area of the base station (B) 31, the radio wave of the base station (B) 31 can be received by the mobile station (A) 34, whereas the mobile station (A) 34 cannot receive the radio wave from the mobile station (B) 35.

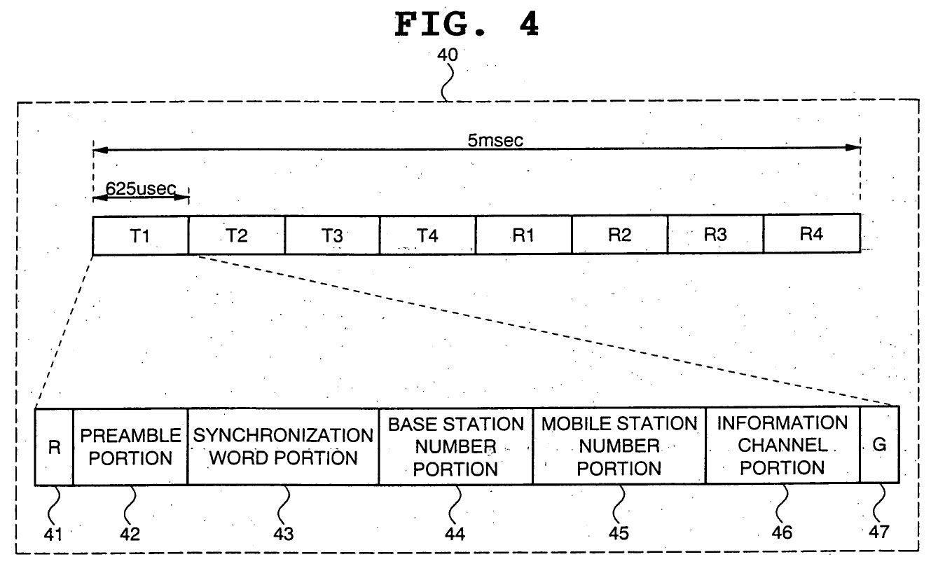

FIG. 4 is an illustration showing a slot construction in the personal handyphone system according to TDMA (Time Division Multiple Access-TDD (Time Division Duplex). As shown in FIG. 4, during a period of 5 msec. four transmission slots (T1 to T4) and four reception slots (R1 to R4) are arranged to constantly use the fourth slot after used transmission slot as the reception slot. Thus, the transmission slot and the reception slot use the same radio frequency.

Furthermore, referring to FIG. 4, each slot is consisted of a lamp bit portion 41, a preamble portion 42, a synchronization word portion 43, a base station number portion 44, a mobile station number portion 45, an information channel portion 46 and a guard bit portion 47.

FIG. 1 is an illustration showing one example of the slot construction for explaining one embodiment of the present invention. By application of the carrier sensing system according to the present invention, it becomes possible to successfully prevent occurrence of radio interference. As one example of a relationship between the time slots of the base station (A) 30 and the base station (B) 31 (see FIG. 3), a relationship between the time slot during communication of the base station (B) 31 and the mobile station (B) 35 and the time slot with which the base station (A) 30 and the mobile station (A) 34 are about initiation of communication.

Referring to FIG. 1, while the base station (B) is in communication, the transmission slot (T3) 17 overlaps with the transmission slot 15 intended to be used for transmission, with which the mobile station (A) 31 is about initiation of communication. The frequency and slot with which the mobile station (A) 34 is about initiation of communication, are designated by the base station 30. However, in the base station (A) 30, as a result of carrier sensing of the reception slot 14 intended to be used for communication, the frequency and slot already used in communication between the base station (B) 31 and the mobile station (B) 35, are designated as the communication frequency and the communication slot since the base station (A) 30 cannot receive the radio wave of the transmission slot 17 in communication of the mobile station (B) 31.

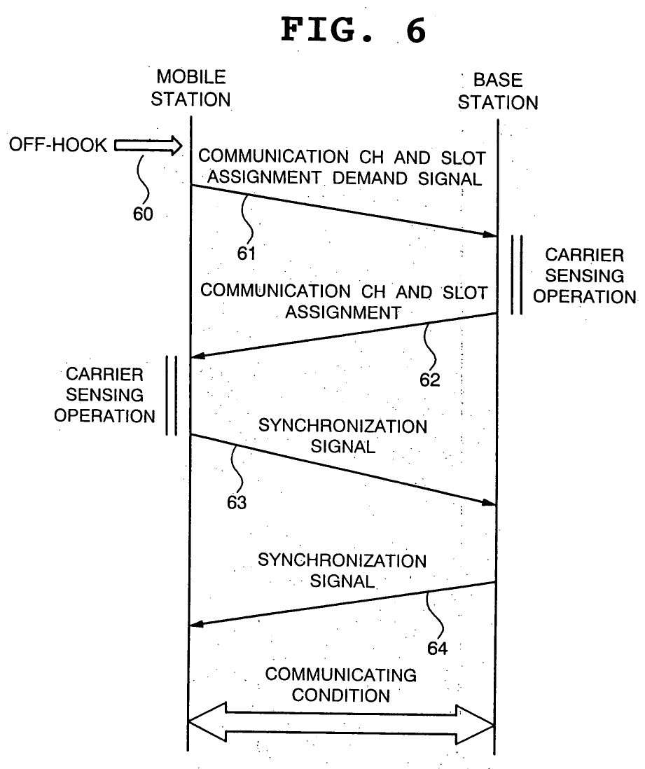

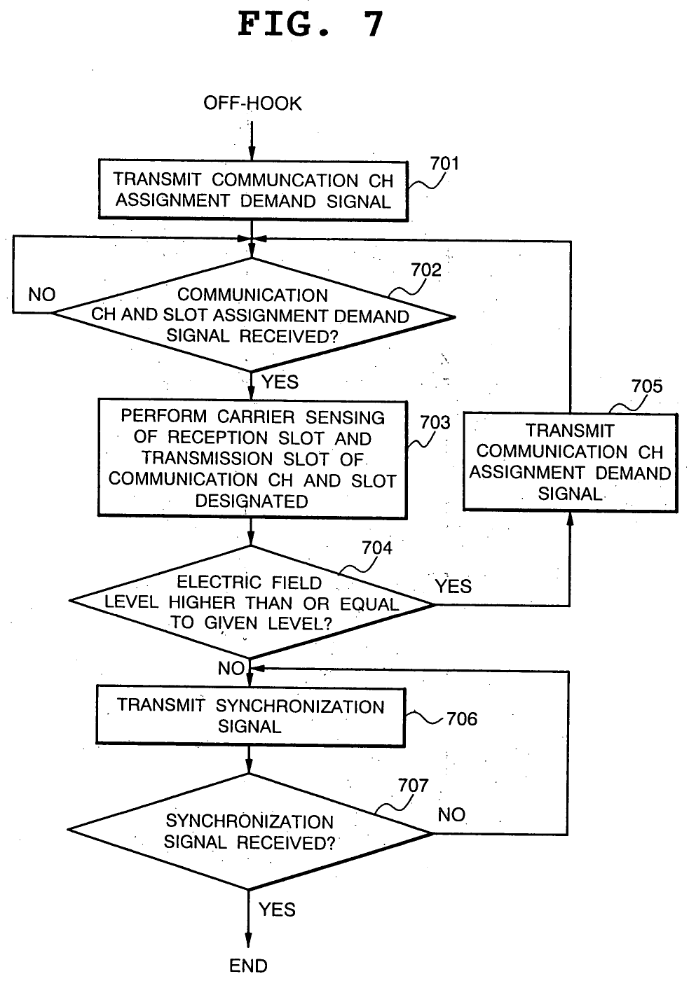

FIG. 6 is a chart showing a communication channel connection sequence in one embodiment of the present invention. On the other hand, FIG. 7 is a flow diagram showing state transition of the communication channel connection of the mobile station in one embodiment of the present invention. Operation of the mobile station (A) 34 will be discussed hereinafter with reference to FIGS. 1, 3, 6 and 7.

By OFF-hook operation of the mobile station (A) 34, the mobile station (A) 34 transmits a communication channel (CH) assignment demand signal 61 to with an up-link controlling slot 13 (step 701) and becomes a reception waiting state of the communication channel (CH) and slot assignment signal (step 702).

In the base station (A) 30, when the communication CH and slot assignment demand signal 61 from the mobile station (A) 31 is received, carrier sensing operation of the reception slot of the arbitrary communication frequency is performed. As a result of carrier sensing, if judgment is made that the communication frequency is not used, the communication CH and slot assignment signal 62 is transmitted to the mobile station (A) 34 with a down-link control slot 10 to designate the communication frequency and the communication slot.

In the example shown in FIG. 1, the third slot is taken as the communication slot and the communication frequency used for communication between the base station (B) 31 and the mobile station (B) 35 is taken as communication frequency.

In the mobile station (A) 34, when the communication CH and slot assignment signal 62 is received from the base station (A) 30, carrier sensing operation of the designated communication frequency and the communication slot is performed (step 703). In the example of FIG. 1, the mobile station (A) 34 performs carrier sensing operation of the reception slot 12 of the third slot as the designated communication slot and the transmission slot 15 of the third slot are performed by respective of the reception slow carrier sensing circuit 28 and the transmission slow carrier sensing circuit 27.

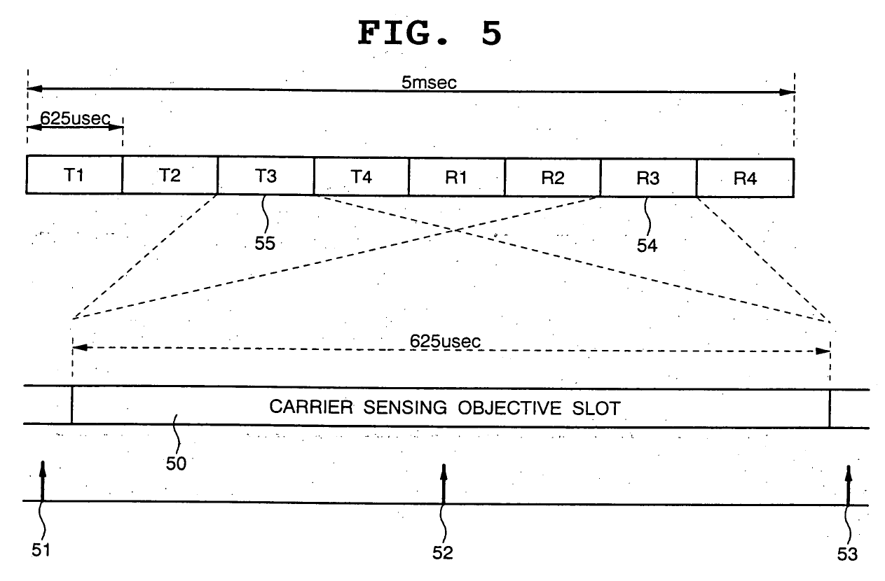

FIG. 5 is an illustration for explaining the carrier sensing point in the mobile station (A) 34. In the mobile station (A) 34, the slot designated by the base station (A) 30 performs measurement of the reception electric field at three points of the front end 51, center 52 and rear end 53 of the slot as carrier sensing points.

In the mobile station (A) 34, the carrier sensing operation of the reception slot 12 and the transmission slot 15 is performed by the reception slot carrier sensing circuit 28 and the transmission slot carrier sensing circuit 27. Upon carrier sensing of the transmission slot 15, it becomes possible to receive the down-link slot transmitted from the base station (B) 31 during communication. Then, the reception electric field level becomes higher than or equal to the given level to make judgment that the relevant slot of the relevant radio frequency is in use (step 704). Again, the communication CH assignment demand signal is transmitted with the up-link control slot 13 (step 705).

Receiving the communication CH assignment demand signal from the mobile station (A) 34, the base station (A) 30 performs the carrier sensing operation again (step 703) to assign the communication frequency different from the precedingly designated communication frequency to the mobile station (A) 34.

The mobile station (A) 34 receives the communication CH and slot assignment signal from the base station (A) 30 to perform the carrier sensing operation again to check whether the communication frequency and slot are used or not. Then, the mobile station (A) 34 transmits the synchronization signal 63 to the base station (A) 30 using the communication frequency and the transmission slot for communication and becomes a waiting state for waiting synchronization signal (steps 706 and 707).

The mobile station (A) 34 becomes communication state after verification of reception of the reception signal 64 with the communication reception slot in the communication frequency.

In the foregoing operation, since the communication frequency in communication of the base station (A) 30 and the mobile station (A) 34 and the communication frequency of the base station (B) 31 and the mobile station (B) 35 are different, radio interference will never be caused even when the mobile station (B) 35 is moved close to the mobile station (A) 34 after initiation of communication.

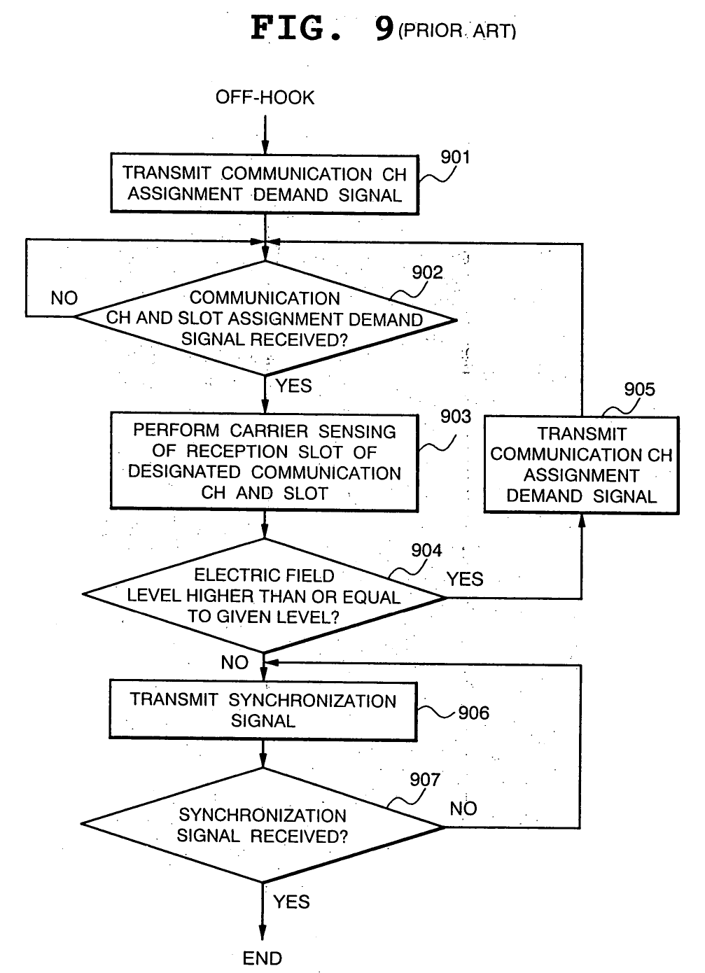

Here, carrier sensing operation in the conventional mobile station will be discussed with reference to FIGS. 1, 3 and 9 as comparative example. In order to perform carrier sensing operation of only reception slot 12 of the communication frequency designated from the base station (A) 30, the mobile station (A) 34 cannot detect communication between the base station (B) 31 and the mobile station (B) 35. Thus, the mobile station (A) 34 and the base station (A) 30 initiate communication at the communication frequency the same as the communication frequency between the base station (B) 31 and the mobile station (B) 35 in communication. Therefore, communication between the base station (A) 30 and the mobile station (A) 34 is performed at the communication frequency the same as the communication frequency between the base station (B) 31 and the mobile station (B) 35 to cause overlapping of the reception slot 12 of the mobile station (A) 34 in communication with the transmission slot 18 of the mobile station (B) 35 in communication when the mobile station (B) 35 moves close to the mobile station (A) 34 to cause radio interference.

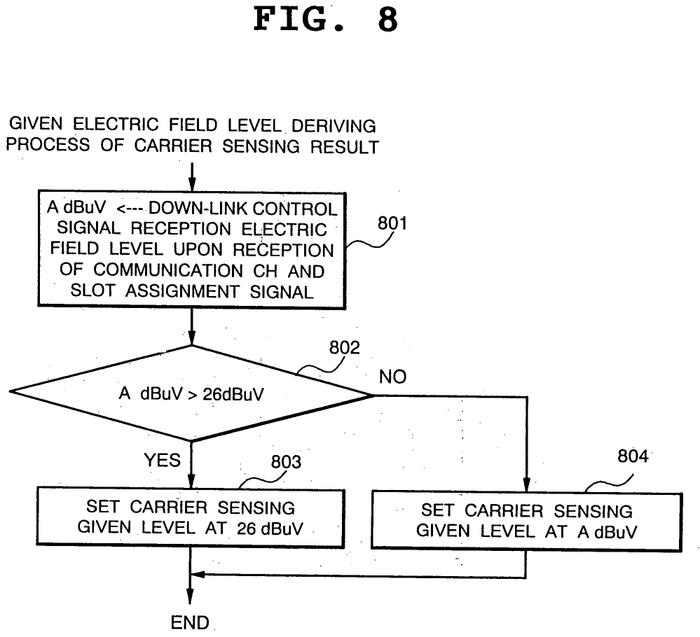

Next, other embodiments of the present invention will be discussed. FIG. 8 is a flow diagram for explaining a judgment method of the carrier sensing result in the second embodiment of the present invention.

Referring to FIGS. 1, 3, 6, 7 and 8, the operation of the mobile station (A) 34 in the second embodiment of the present invention will be discussed hereinafter.

By OFF-hook operation of the mobile station (A) 34 (step 701), the communication CH assignment demand signal 61 (see FIG. 6) is transmitted to the base station (A) 30 by the up-link control slot 13 (see FIG. 1).

Then, the mobile station (A) 34 becomes waiting state for waiting the communication CH and slot assignment signal (step 702).

The base station (A) 30 is responsive to the communication CH and slot assignment demand signal 61 from the mobile station (A) 34 to perform carrier sensing of the reception slot at the arbitrary communication frequency. When the reception slot for which carrier sensing is effected, is judged as not being used, the communication frequency and the communication slot are designated for the mobile station (A) 34 by the down-link control slot 10 (see FIG. 1) by the communication CH and slot assignment signal 62 (see FIG. 6).

The mobile station (A) 34 stores the reception electric field level of the communication CH and slot assignment signal 62 (see FIG. 6) received through the down-link control slot (see FIG. 1) from the base station (A) 30 (step 801).

The mobile station (A) 34 performs carrier sensing operation of the communication frequency and the communication slot designated by the base station (A) 30 (step 703).

FIG. 5 shows a carrier sensing point of the mobile station (A) 34. The mobile station (A) 34 takes the slot designated by the base station (A) 30 as a carrier sensing objective slot 50. As the carrier sensing point, electric field measurement at three points of the front end 51, the center 52 and the rear end 53 of the slot, is performed.

The mobile station (A) 34 is set the reception electric field value of a judgment reference of the carrier sensing result normally at 26 dBuV according to the first edition of standard specification RCR STD-28 (established on Dec. 20, 1993). When the reception electric field level of the communication CH and slot assignment signal 62 received from the base station (A) 30 through the down-link control slot 10 is in excess of 26 dBuV, the given level for carrier sensing is set at 26 dBuV (step 803).

When the reception electric field level of the communication CH and slot assignment signal 62 received from the base station (A) 30 through the down-link control slot 10 becomes lower than 26 dBuV, the given level for carrier sensing is set at the reception electric field level of the communication CH and slot assignment signal 62 received from the base station (A) 30 through the down-link control slot 10 (step 804).

By the foregoing control, when an interference wave higher than the reception electric field value of the control signal received through the down-link control slot 10 of the base station (A) 30 is present, even if the electric field level of the interference wave is lower than or equal to 26 dBuV defined by the first edition of the standard specification RCR STD-28 (established on Dec. 20, 1993), occurrence of radio interference can be successfully prevented by detecting high possibility of occurrence of radio interference upon entry into communication state at the same frequency.

As set forth above, by the carrier sensing system of the personal handyphone system according to the present invention, when the transmission slot of the own mobile station has already been used by other mobile station or when other mobile station moves close to the own mobile station or the own mobile station moves close to other mobile station after initiation of Communication in the own mobile station, radio interference can be prevented successfully.

Furthermore, according to the present invention, by making the defined value for carrier sensing judgment variable, initiation of communication at the communication frequency possibly cause radio interference can be successfully prevented before initiation of communication.

Although the present invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodied within a scope encompassed and equivalents thereof with respect to the feature set out in the appended claims.

What is claimed is:

1. A personal handyphone system performing radio connection using a time division multiple access-time division duplex system comprising:
a mobile station including
means for performing carrier sensing of a communication frequency designated by a base station and a reception slot; and
means for performing carrier sensing of a transmission slot.

2. A personal handyphone system as set forth in claim 1, wherein said mobile station further comprises:
means for initiating communication when non use is judged in both carrier sensing.

3. A personal handyphone system as set forth in claim 1, wherein said mobile station further comprises:
means for initiating communication when non use is judged in both carrier sensing,
in carrier sensing of said reception slot and carrier sensing of said transmission slot, setting of reception electric field level as judgment condition of non use is provided individually to perform carrier sensing on the basis of each of said reception electric field levels.

4. A personal handyphone system as set forth in claim 1, wherein said mobile station further comprises:
means for initiating communication when non use is judged in both carrier sensing;
setting means for modifying and setting said reception electric field level as non use judgment condition in carrier sensing,
said setting means setting said reception electric field level as non use judgment condition at an appropriate value corresponding to a reception electric field level of a control frequency and a control slot from said case station.

5. A personal handyphone system as set forth in claim 1, wherein said mobile station further comprises:
means for initiating communication when non use is judged in both carrier sensing;
setting means for modifying and setting said reception electric field level as non use judgment condition in carrier sensing,
in carrier sensing of said reception slot and carrier sensing of said transmission slot, setting of reception electric field level as judgment condition of non use is provided individually to perform carrier sensing on the basis of each of said reception electric field levels,
setting means for modifying and setting said reception electric field level as non use judgment condition in carrier sensing,
said setting means setting said reception electric field level as non use judgment condition at an appropriate value corresponding to a reception electric field level of a control frequency and a control slot from said case station.

6. A carrier sensing method on a mobile station side of a personal handyphone system performing radio connection using a time division multiple access-time division duplex system comprising:
in said mobile station,
performing carrier sensing of a communication frequency designated by a base station and a reception slot; and
performing carrier sensing of a transmission slot.

7. A carrier sensing method as set forth in claim 6, which further comprising the step of, in said mobile station,
initiating communication when non use is judged in both carrier sensing.

8. A carrier sensing method as set forth in claim 6, which further comprising the step of, in said mobile station,
initiating communication when non use is judged in both carrier sensing,
in carrier sensing of said reception slot and carrier sensing of said transmission slot, setting of reception electric field level as judgment condition of non use is provided individually to perform carrier sensing on the basis of each of said reception electric field levels.

9. A carrier sensing method as set forth in claim 6, which further comprising the step of, in said mobile station, initiating communication when non use is judged in both carrier sensing;
modifying and setting said reception electric field level as non use judgment condition in carrier sensing,
setting said reception electric field level as non use judgment condition at an appropriate value corresponding to a reception electric field level of a control frequency and a control slot from said case station.

10. A carrier sensing method as set forth in claim 6, which further comprising the step of, in said mobile station, initiating communication when non use is judged in both carrier sensing;
modifying and setting said reception electric field level as non use judgment condition in carrier sensing,
in carrier sensing of said reception slot and carrier sensing of said transmission slot, setting of reception electric field level as judgment condition of non use is provided individually to perform carrier sensing on the basis of each of said reception electric field levels,
modifying and setting said reception electric field level as non use judgment condition in carrier sensing,
setting said reception electric field level as non use judgment condition at an appropriate value corresponding to a reception electric field level of a control frequency and a control slot from said case station.

11. A mobile station of a personal handyphone system performing radio connection using a time division multiple access-time division duplex system comprising:
means for performing carrier sensing of a communication frequency designated by a base station and a reception slot; and
means for performing carrier sensing of a transmission slot.

12. A mobile station as set forth in claim 11, which further comprises:
means for initiating communication when non use is judged in both carrier sensing.

13. A mobile station as set forth in claim 11, which further comprises:
means for initiating communication when non use is judged in both carrier sensing,
in carrier sensing of said reception slot and carrier sensing of said transmission slot, setting of reception electric field level as judgment condition of non use is provided individually to perform carrier sensing on the basis of each of said reception electric field levels.

14. A mobile station as set forth in claim 11, which further comprises:
means for initiating communication when non use is judged in both carrier sensing;
setting means for modifying and setting said reception electric field level as non use judgment condition in carrier sensing,
said setting means setting said reception electric field level as non use judgment condition at an appropriate value corresponding to a reception electric field level of a control frequency and a control slot from said case station.

15. A mobile station as set forth in claim 11, which further comprises:
means for initiating communication when non use is judged in both carrier sensing;
setting means for modifying and setting said reception electric field level as non use judgment condition in carrier sensing,
in carrier sensing of said reception slot and carrier sensing of said transmission slot, setting of reception electric field level as judgment condition of non use is provided individually to perform carrier sensing on the basis of each of said reception electric field levels,
setting means for modifying and setting said reception electric field level as non use judgment condition in carrier sensing,
said setting means setting said reception electric field level as non use judgment condition at an appropriate value corresponding to a reception electric field level of a control frequency and a control slot from said case station.
